(19) United States
(12) Patent Application Publication
(10) Pub. No.: US 2006/0063563 A1
(43) Pub. Date: Mar. 23, 2006

(54) Cell phone system with automatic ringer/vibrate/silent/operating mode settings based on entering/exiting public areas and theaters

(76) Inventor: Richard Dana Kaufman, Saugus, MA (US)

Correspondence Address: Richard Dana Kaufman, 404 Rock Wood Drive, Saugus, MA, 01906, US

(21) Appl. No.: 10/944,547

(22) Filed: Sep. 18, 2004

(51) Int. Cl. H04M 1/00

(52) U.S. Cl. 455/556.2

(57) ABSTRACT

A device and system for remotely setting the ringer/vibrate/silent modes and other operations of cell phones and beepers in public areas. It has become routine that people are asked to shut off the ringers of their cell phones in public places such as movie theaters, libraries, performances, lectures, courthouses, classes, work places, meetings, auditoriums etc. Some places, such as libraries, have started to fine cell phone users when their cell phone ringer goes off. The invention automatically sets cell phones to comply with settings necessary for particular public areas. This is a convenience for people with cell phones who will no longer need to be reminded to comply with ringer modes in public areas. It is also a convenience for other people in a public area who would be annoyed by people with cell phones who neglected to shut off ringers. Finally it frees organizers of the theater or public area from constantly needing to remind people with cell phones to turn off cell phone ringers. A significant feature of the invention is the ability to remotely control cell phone type devices based on locations such as public areas. This type of control over cell phone type devices offers additional advantages for safe operation in airplanes and or cars.

### TECHNICAL FIELD

The invention concerns setting the ringer and silent modes of cell phones and beepers in public places. The invention concerns the setting of these modes remotely by entering or exiting public places such as theaters, libraries, and auditoriums.

### BACKGROUND OF THE INVENTION

Cell phones have become a common part of everyday life. They represent a convenience for the user. People take their cell phones with them to many different places, including public areas such as schools, movie theaters, libraries, auditoriums, speeches, etc. When cell phones or beepers ring in public places, other people get annoyed. Sometimes serious disturbances are caused when people get upset.

The situation has become so common that movie theaters constantly remind people to turn their cell phone ringers off by setting them to silent or vibrate mode. People giving speeches or performances ask that cell phone ringers be shut off due to the obvious distraction. Libraries have begun fining people if their cell phone ringers go off.

Even when people comply with the request to set their cell phones to vibrate, the user is not usually able to get to a non-public area in time to take the call. Also, some people forget to reset their phone to ringer mode upon exiting a public area and end up missing calls.

Some people are calling for further legislation of cell phone use in public areas and airplanes. Cell phone use upon airplanes represents an even more serious concern due to the possibility of interacting with airplane instrumentation during takeoff and landing.

There are even times that the cell phone user wants the cell phone ringer turned off routinely. At places of work, people usually set their cell phones to vibrate in order to avoid bothering coworkers. It can be a hassle to remember to constantly set and unset the ringer when going to and leaving work respectively. Missed calls can occur when users forget to turn the ringer back on.

### SUMMARY OF THE INVENTION

In one form of the invention, transmitter probes are placed at the entrance and exits of public areas. Signs inform users that cell phones and beepers will be set to silent, vibrate, or text only mode while in the public area. When a cell phone user passes by the transmitters for the first time in a public place, the cell phones stores the current “entrance” mode of the phone and then sets the mode to silent. Upon exiting the public place, the cell phone user passes by a transmitter that sets the cell phone back to its “entrance” or stored mode.

In one form of the invention, the cell phone user can preset automated messages to anyone that calls while the user is in a public place. Also, the cell phone user can respond to any calls received in silent mode by selecting a key. An automated message says that the call recipient is in a public area and is moving to an area where the call can be taken. The call is then placed on hold while the user moves to a new location. The call can then be taken by pressing a keypad button.

### BRIEF DESCRIPTION OF THE DRAWINGS

FIG. 1 illustrates the ringer/silent modes of a cell phone being set by a signal after passing a transmitter or probe.

FIG. 2 illustrates a theater or auditorium where all entrances and exits have probes such that the ringer/silent modes of a cell phone are set when entering or exiting.

### DETAILED DESCRIPTION OF THE INVENTION

The invention provides for a remote or external method of controlling cell phone modes or operation based on location. The locations are public areas where cell phones need to automatically be switched between ringer and silent modes.

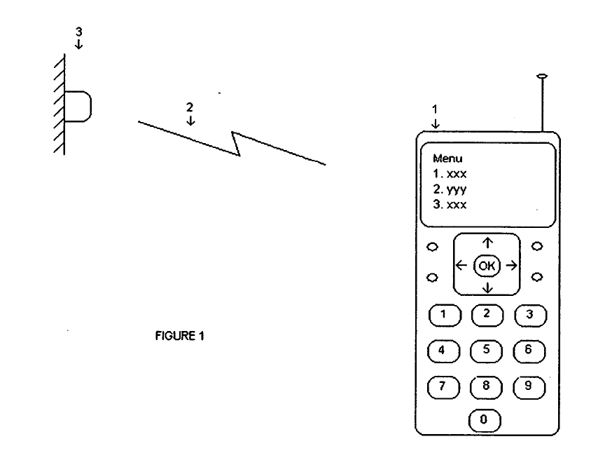

FIG. 1 illustrates a cell phone 1 being set to ringer or silent mode from a signal 2 by a transmitter or probe 3.

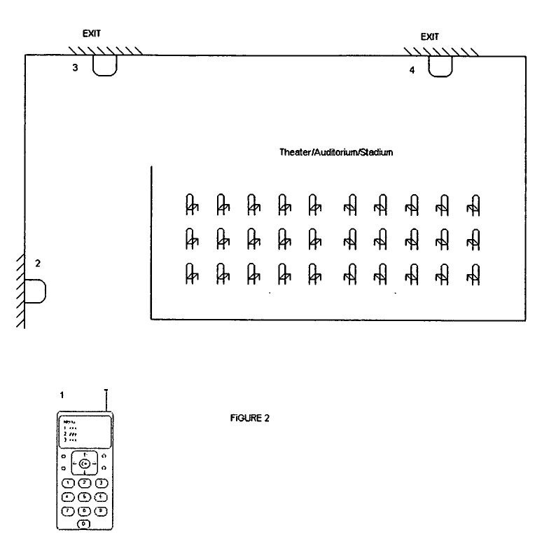

FIG. 2 illustrates one form of the invention where a cell phone 1 passes a wall-mounted signal transmitter probe 2 at the entrance to a theater. The cell phone receives a signal from probe 1 and determines that it is entering a public area since the mode was not set previously. Then the cell phone stores the current settings of the cell phone before setting the silent mode. The silent mode is either a vibrate mode, text mode or another mode that alerts the person carrying the cell phone to calls or emergencies without sounding a ringer or sounds. Upon exiting the public area, the cell phone must pass by probe 1 again or probes 2 or 3 at the emergency exits to the theater. Upon passing a probe again, the cell phone receives a signal and determines that a non-public area mode must be set since the public area mode had been set. The cell phone then sets the cell phone back to the settings prior to entering the public area.

A cell phone device is used for illustration purposes, but the device could be a beeper, PDA (Personal Digital Assistants), computer, or notebook computer that receives a signal. When a cell phone user passes by any probe, in any direction, the cell phone mode is switched from its previous state. A sign on the entrances announces that the settings are being made. The control inside a cell phone responds to wall-mounted transmitters and signals in order to activate or deactivate the cell phone ringer as appropriate. The cell phone could be preset to alert, beep, vibrate or do nothing when passing through areas where the probe is switching settings.

The cell phone can be preset such that vibrate mode, text only mode, or some other form of silent mode is used in public areas. The cell phone is either set from silent mode to ringer mode, or ringer mode to silent mode. The cell phone switches between public-area mode and non-public area mode every time it passes a signal probe.

The probes can be any type of trigger or transducer such as a proximity sensor, messaging transmitter, GPS (Global Positioning Signal), radio, digital, analog, or electronic based signal transmitter. The reach or field of the transmitter can be varied to the particular entrance or event. The probes work to send signals to multiple cell phones passing by at the same time. Also, bi-directional field probes can be used as well as more than one probe at an entrance or exit to identify if a cell phone is entering or exiting a public area. If there is more than one probe per exit, the order of signals from the probes can indicate that a person is entering or exiting the theater.

In another form of the invention, a general area field transmitter can be used to capture the area of the public area. Only one transmitter is needed in the entire public area and the cell phone is set to silent mode while within the field.

A variety of mechanisms are available to perform the function of the trigger or transmitter probe. One example adapts the technology used to automatically set the time on cell phones as the phone travels through different time zones. The location of the cell phone is used to set the time of the cell phone. This invention sets the ringer/vibrate/silent mode of the phone based on location. Other examples of hardware that can perform the function of the trigger mechanism are RFID (Radio Frequency Identification) devices from Motorola, Speedpass Cards that set Mobile Gas Pumps, GPS systems, Fastlane/EZ-Pass Transponder type devices for drive thru tolls, proximity key cards used to enter buildings, and other wireless or remote systems.

If a cell phone receives a call while in a public area, the caller can be informed by preset messages that the call recipient is in a public area. If the call recipient selects a button or menu, then another automated message can inform the caller that the call recipient is moving to another area to take the call. This allows the call recipient to put the call on hold instead of having to start speaking while still in the public area. Other possibilities include allowing callers to perform emergency breakthroughs to activate the ringer after the caller acknowledges a message that the call recipient is in a public area. Settings can be made which dictate that a predefined emergency ring cannot go off for a specific amount of time after the call. This could allow times, such as one minute, for the call recipient to reach a non-public location before the ringer will go off.

There can also be other control features for the cell phone. The cell phone can contain a switch, button, or menu that allows a person to select the type of silent mode that should be used. This can be vibrate, text only, or picture modes when inside a public area. Additional controls could prevent the remote signal from shutting off the ringer. This can be done for users who require immediate alerts to emergencies. Also, a preset list of caller ID's can be entered to allow ringer calls from high priority callers. This allows a user to retain control of the phone while still allowing the convenience afforded by the invention for all other lower priority calls while in a public area. In any case, the phone can still be used to call out.

Use of cell phones on airplanes has been a concern due to the effect of cell phone interference with airplane instrumentation. A form of the invention can be used to control whether a cell phone is on or off, or can be turned on. This is primarily an issue while in an airplane during takeoff or landings. The pilot can control whether or not cell phones can operate or be powered on. This type of control over cell phones may be legislated for significant risk areas such as airplanes. The possibility of extending this type of control to cars also exists. This can prevent cell phones from being used in cars while they are moving. The actual signal can be received which alerts the cell phone user to a call. However, no communication can take place while the car is moving.

Other applications of remotely controlling a cell phone on or off include test centers, game shows, and classrooms. This can be done to prevent passing information and text messages between people.

In one form of the invention, a geographic area, such as a movie theatre, library, etc., is defined in which unnecessary noise is prohibited. People may transport devices that issue audible signals into the area. The invention detects entry of the devices into the area, and disables the audible signals. Also, the invention can detect exit of the devices from the area, and re-enable the audible signals.

It is understood that variations of the idea could be made without changing the true spirit of the idea. Examples of such variations include remotely controlling cell phone modes using computer transmitters, other cell phones, or phone calls to a cell phone. The invention is for control over cell phone type devices based on locations and areas. This type of control extends to operation in airplanes and or cars.

What is claimed is:

1. A system comprising of a cell phone, beeper, PDA (Personal Digital Assistants), computer, or notebook computer that normally receives a signal and:
a) accepts a signal for setting ringer, vibrate, text only and or on/off modes using the existing receiver or a new/alternate receiver;
b) stores device settings such as ringer mode when passing a remote signal upon entering a public place;
c) alerts people of changes made to device settings using beeps, sounds, messages, or vibrations upon entering or exiting a public area;
d) sets the device sound on or off according to a remote signal;
e) sets the device ringer and or beep mode to on or off according to a remote signal;
f) sets the vibrate or silent mode to on or off according to a remote signal;
g) sets the volume according to a remote signal;
h) sets the device startup sound to on or off according to a remote signal;
i) sets the device on or off according to a remote signal;
j) controls all device operations such as putting calls on hold and relaying messages to the caller;
k) resets the device to its previous state or settings in memory upon exiting a public place and passing by a remote signal;
l) stores calls and caller ID's of all missed calls during the time that the cell phone was in a public place;
m) alerts people via beeps, sound, messages, or vibrations of calls received when exiting a public area;
n) includes a device signal receiver, which may be a separate receiver from the device's own signal receiver, which controls functions and settings of the device.

2. Apparatus according to claim 1, comprising:
a) a means of transmitting a signal to the devices of claim 1;
b) a probe, proximity sensor, messaging transmitter, GPS (Global Positioning Signal), radio, digital, analog, or electronic signal based on (a);
c) a transmitter of (b) located at the entrance and exits of public areas that sets the modes and settings of the device of claim 1;
d) an alternative transmitted signal that encompasses the general area of the public area.

3. A system according to claim 1, and further comprising:
a) a system to alert callers through automated messages, voice messages or text that the call recipient is in a public area;
b) a system where the call recipient can press a button or select from a menu to alert the caller with automated messages, voice messages or text that the call recipient will take the call upon leaving the public area;
c) a system that places the call on hold while the call recipient moves to a different location according to (b).

4. A system according to claim 3, and further comprising:
a) a method for accepting emergency calls via preset emergency caller ID lists;
b) an override switch, button or menu to prevent setting the cell phone modes with a remote signal.

5. A system according to claim 1 where the transmitted signal is set by calling the cell phone directly through prearranged lists for meeting attendees.

6. A system of claim 1 where the device searches for a reflector, probe, or bar code for setting the modes upon entering or exiting public areas.

7. An electronic device, comprising:
a) an annunciator that produces an audible signal;
b) means for
i) detecting entry of the device into a geographical zone; and
ii) in response, preventing the annunciator from producing audible signals.

8. Device according to claim 7, and further comprising:
a) means for
i) detecting exit of the device from the zone, and
ii) in response, enabling the annunciator to produce audible sounds.

9. Device according to claim 7, wherein the device comprises a cell phone.

10. A system, comprising:
a) a predefined geographical zone;
b) means for issuing signals, which are effective to disable annunciators on electronic devices, which enter the zone.

11. System according to claim 10, wherein the zone has an entrance and the means is located at the entrance.

12. System according to claim 10, and further comprising means for issuing signals that are effective to enable annunciators on electronic devices that leave the zone.
